(19) United States
(12) Patent Application Publication
(10) Pub. No.: US 2026/0260282 A1
(43) Pub. Date: Sep. 3, 2026

(54) SYSTEM

(71) Applicant: SOFTBANK GROUP CORP., Tokyo (JP)

(72) Inventor: Rui YANAGI, Tokyo (JP)

(73) Assignee: SOFTBANK GROUP CORP., Tokyo (JP)

(21) Appl. No.: 19/554,750

(22) Filed: Mar. 3, 2026

Related U.S. Application Data
(60) Provisional application No. 63/766,253, filed on Mar. 3, 2025.

(51) Int. Cl. G06Q 30/0601; G06V 20/62; G06V 30/10

(52) U.S. Cl. CPC G06Q 30/0633; G06V 20/62; G06V 30/10

(57) ABSTRACT

A system that supports efficient meal planning and ingredient purchasing based on the user's family composition, food preferences, allergy information, health status, and information about ingredients in the refrigerator is disclosed. The user inputs this information using a terminal, and the server proposes a week's worth of meal plans based on it. Furthermore, it utilizes supermarket special sale information and past purchase history to generate a shopping list that minimizes costs. It also calculates the calories of the proposed meal plans and manages food expenses, supporting a healthy diet. Users can flexibly modify the proposed meal plans according to their actual circumstances, and the system provides optimal meal plans and shopping plans using generative AI. This enables users to save time and money, reduce waste, and achieve a diet tailored to their individual needs.

### CROSS-REFERENCE TO RELATED APPLICATION

This application claims priority under 35 U.S.C. § 119 to U.S. Provisional Patent Application No. 63/766,253, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

System and method for reducing the time and effort burden in daily meal planning and streamlining ingredient purchasing is disclosed. Specifically, considering meal plans that accommodate family preferences, allergies, and health conditions is time-consuming and a source of stress for many people. Furthermore, efficiently utilizing ingredients in the refrigerator and taking advantage of sale information to reduce food expenses are important challenges in household budget management. Furthermore, planning optimal shopping within a budget by utilizing past purchase history is necessary to reduce financial burden. This invention aims to solve these problems by providing meal plan suggestions tailored to the user's individual needs and generating efficient shopping lists, thereby saving time and costs and supporting a healthy

A system equipped with a user information registration unit, a refrigerator management unit, an image recognition unit, a receipt reading unit, a meal plan proposal unit, a shopping list generation unit, a calorie calculation unit, a food expense management unit, and a meal plan revision unit is disclosed. This system serves as a means to reduce the time and effort burden of daily meal planning and to streamline ingredient purchasing. The User Information Registration Unit enables personalized meal plan suggestions by registering family preferences, allergy information, health conditions, and the user's repertoire of dishes they can prepare. The Refrigerator Management Unit manages the types, quantities, and expiration dates of ingredients inside the refrigerator, supporting the efficient use of existing ingredients without waste. The Image Recognition Unit captures supermarket flyer information using image recognition technology and extracts special sale information, promoting cost-effective ingredient purchases. The Receipt Scanning Module uses OCR technology to read past receipts and record purchase history, enabling optimal shopping plans within budget.

The Meal Proposal Module suggests weekly meal plans based on this information, while the Shopping List Generator creates lists of necessary ingredients and suggests purchase locations. The Calorie Calculator computes the calories of proposed meals to support health management. The Food Expense Management section verifies if purchases fit within the budget and manages food expenses. The Menu Modification section allows users to adjust proposed menus to actual circumstances, enabling flexible meal planning. This helps users save time and money while maintaining a healthy diet.

### BRIEF DESCRIPTION OF THE DRAWINGS

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

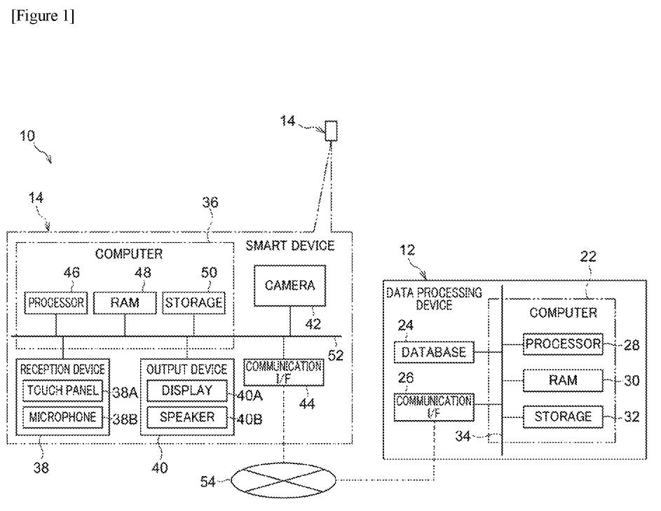

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. are connected to a bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, and presents data to user 20 by outputting it in a form perceptible to user 20 (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

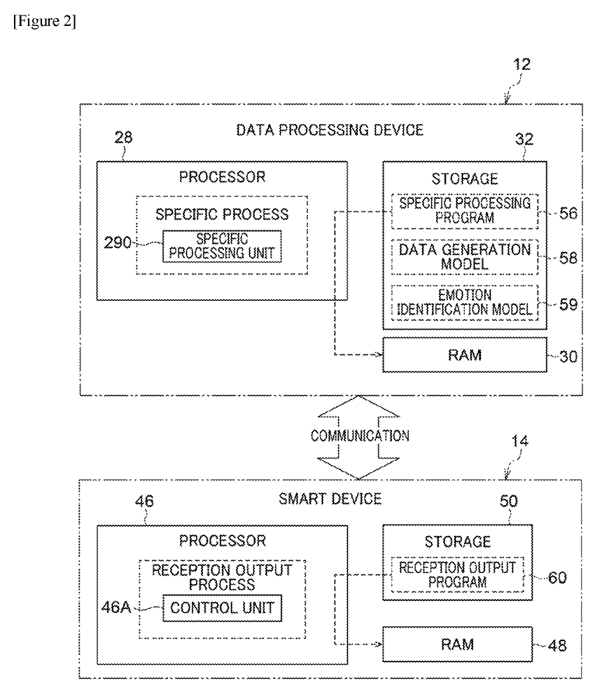

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" pertaining to the technology of this disclosure. Processor 28 reads specific processing program 56 from storage 32 and executes the read specific processing program 56 in RAM 30. Program 56 is an example of a "program" related to the technology of this disclosure. Processor 28 reads specific processing program 56 from storage 32 and executes the read specific processing program 56 on RAM 30. The specific processing is realized by processor 28 operating as specific processing unit 290 according to specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

As an embodiment for implementing the present invention, the system is realized on both the server and the terminal, and the specific functioning of each component is described in detail.

First, the user information registration unit is implemented on the terminal. Using a terminal such as a smartphone or tablet, the user inputs detailed information about family members' food preferences, allergy information, health conditions, and their own cooking repertoire. For example, information can be registered about family members who like spicy food or have a dairy allergy. Regarding health conditions, information can be entered about members requiring low-sugar diets due to diabetes or low-salt diets due to high blood pressure. Furthermore, for dishes the user can prepare, categories such as Japanese, Western, Chinese, or vegetarian cuisine can be selected, and specific dish names can be entered. This information is sent to the server and stored in the database.

Next, the refrigerator management function is implemented on both the terminal and the server. Using the terminal, the user can input detailed information about the types, quantities, and expiration dates of ingredients inside the refrigerator. For example, they can input information such as 6 eggs, 500ml of milk, 3 tomatoes, and 300g of chicken. By also inputting expiration dates, the system manages the consumption deadlines of ingredients, helping to reduce waste. This information is sent to the server and stored in the database. Based on this information, the server manages the inventory status of ingredients and proposes meal plans that prioritize the use of ingredients with approaching expiration dates.

The image recognition component is implemented on the terminal. The user takes a photo of the supermarket flyer using the terminal's camera. Image recognition technology automatically extracts information on special offers and new products. For example, it can capture information such as chicken at 30% off, cabbage at ¥100 per head, or two bottles of milk for ¥300. This information is sent to the server and stored in the database. Based on this information, the server proposes cost-effective meal plans.

The receipt scanning function is also implemented on the device. Users take photos of past receipts using the device's camera. OCR technology enables detailed reading of purchased item names, quantities, and prices. For example, it extracts information such as milk for 200 yen, bread for 150 yen, tomatoes for 100 yen, sends it to the server, and stores it. The server analyzes this past purchase history to create an optimal shopping plan within the budget.

The meal plan proposal function is implemented on the server. Based on information obtained from the user information registration function, refrigerator management function, image recognition function, and receipt reading function, the server proposes detailed meal plans for a week. For example, it presents specific dish names and recipes such as: Monday breakfast "Omelet and Salad," lunch "Chicken Sandwich," dinner "Chicken Curry"; Tuesday breakfast "Yogurt and Fruit," lunch "Tomato Pasta," dinner "Grilled Fish." Recipes include ingredients used, cooking steps, cooking time, and calorie information.

The shopping list generation component is also implemented on the server. Based on the proposed meal plan, the server generates a detailed shopping list of necessary ingredients. For example, it suggests specific purchase locations and quantities such as "Purchase 500g of chicken at Supermarket A," "Purchase 2 tomatoes at Supermarket B," and "Purchase 1L of milk at Supermarket C." Furthermore, it utilizes sale information to select the most economical purchase locations.

The calorie calculation unit is implemented on the server. The server calculates the calories of the proposed meal plan in detail and displays the total daily calorie intake. This facilitates health management for the user. For example, the user can adjust the meal plan to ensure the total daily calorie intake does not exceed 2000 kcal.

The food expense management unit is also implemented on the server. The server verifies whether purchases can be made within the budget and manages food expenses. For example, if the weekly budget is ¥5,000 and the ingredient cost for the proposed menu is ¥4,800, it indicates this. Furthermore, based on past purchase history, it suggests budget revisions or savings.

Finally, the Menu Modification Module is implemented on the terminal. Users can flexibly modify the proposed menu on the terminal to suit actual circumstances. For example, if a sudden schedule change requires eating out, they can delete that day's meal plan and carry it over to the next day. They can also request a new meal plan proposal based on changes in family preferences.

In this way, the coordinated operation of the server and terminal enables users to efficiently plan menus and optimize ingredient purchases. This saves time and costs while supporting a healthy diet.

### System Configuration

The system according to this embodiment comprises a user information registration unit, a refrigerator management unit, an image recognition unit, a receipt reading unit, a meal plan proposal unit, a shopping list generation unit, a calorie calculation unit, a food expense management unit, and a meal plan modification unit. The user information registration unit allows users to input detailed information about their family's food preferences, allergy information, health status, and their own repertoire of dishes they can prepare. For example, the user can use a terminal to register information about family members who like spicy food or have a dairy allergy. Regarding health conditions, the user can input information about members requiring low-sugar diets due to diabetes or low-salt diets due to hypertension. Furthermore, for dishes the user can prepare, the user can select categories such as Japanese, Western, Chinese, or vegetarian cuisine and input specific dish names. This information is sent to the server and stored in the database.

The refrigerator management section allows users to input detailed information about the types, quantities, and expiration dates of ingredients inside the refrigerator. This information is then sent to the server for management. For example, users can input details such as 6 eggs, 500ml of milk, 3 tomatoes, and 300g of chicken. By also entering expiration dates, users can manage the consumption deadlines of ingredients and reduce waste. Based on this information, the server manages the inventory status of ingredients and proposes menus that prioritize the use of ingredients nearing their expiration dates.

The image recognition unit allows users to photograph supermarket flyers and automatically extracts information on special sales and new products using image recognition technology. For example, it can capture information such as chicken at 30% off, cabbage at ¥100 per head, or two bottles of milk for ¥300. This information is sent to the server and stored in the database. Based on this information, the server proposes menus designed to minimize costs.

The receipt scanning unit allows users to photograph past purchase receipts. Using OCR technology, it reads detailed information such as purchased product names, quantities, and prices. For example, it extracts information like milk 200 yen, bread 150 yen, tomatoes 100 yen, etc., and sends this information to the server for storage. Based on this information, the server analyzes past purchase history and creates an optimal shopping plan within the budget.

The meal plan proposal unit operates on the server. Based on information obtained from the user information registration unit, refrigerator management unit, image recognition unit, and receipt scanning unit, it proposes detailed meal plans for a week. For example, it presents specific dish names and recipes such as: Monday breakfast "Omelet and Salad," lunch "Chicken Sandwich," dinner "Chicken Curry"; Tuesday breakfast "Yogurt and Fruit," lunch "Tomato Pasta," dinner "Grilled Fish." Recipes include ingredients used, cooking steps, cooking time, and calorie information.

The shopping list generation unit operates on the server to generate a detailed shopping list of necessary ingredients based on the proposed menu. For example, it suggests specific purchase locations and quantities, such as "Purchase 500g of chicken at Supermarket A," "Purchase 2 tomatoes at Supermarket B," and "Purchase 1L of milk at Supermarket C." Furthermore, it utilizes sale information to select the most economical purchase location.

The calorie calculation unit operates on the server to calculate the detailed calories of the proposed meal plan and present the total daily calorie intake. This facilitates health management for the user. For example, the user can adjust the meal plan to ensure the total daily calorie intake does not exceed 2000 kcal.

The Food Expense Management Unit operates on the server to verify whether purchases can be made within the budget and to manage food expenses. For example, it indicates that the weekly budget is ¥5,000 and the ingredient cost for the proposed menu is ¥4,800. Furthermore, based on past purchase history, it suggests budget revisions or savings measures.

The Menu Modification Module operates on the terminal, allowing users to flexibly modify proposed menus to fit actual circumstances. For example, if a sudden schedule change requires eating out, the user can delete that day's menu and carry it over to the next day. It can also re-propose menus based on changes in family preferences.

Specific examples of prompt sentences to feed into the generative AI required to implement the present invention include: "Please propose a one-week meal plan considering the user's family composition and food preferences," "Please devise a meal plan that efficiently utilizes ingredients in the refrigerator without waste," and "Please generate the most economical shopping list based on sale information." This enables the system to provide optimal meal plans and shopping plans tailored to the user's needs.

### Implementation Steps

Step 1: User Information Registration

Users input detailed information about their family's food preferences, allergy information, health conditions, and their own cooking repertoire using a terminal. For example, they can register information about family members who like spicy food or have dairy allergies. Regarding health conditions, users can input information about members requiring low-sugar diets due to diabetes or low-salt diets due to hypertension. Furthermore, for dishes the user can prepare, they can select categories such as Japanese, Western, Chinese, or vegetarian cuisine and input specific dish names. This information is sent to the server and stored in the database.

Step 2: Refrigerator Ingredient Management

Users input detailed information about the types, quantities, and expiration dates of ingredients in the refrigerator using the terminal. For example, they can input information such as 6 eggs, 500ml of milk, 3 tomatoes, and 300g of chicken. By also inputting expiration dates, users can manage the consumption deadlines of ingredients and reduce waste. Based on this information, the server manages ingredient inventory status and proposes meal plans that prioritize using ingredients nearing their expiration dates.

Step 3: Obtaining Supermarket Special Offer Information

Users take photos of supermarket flyers using their device's camera. Image recognition technology automatically extracts information on special offers and new products. For example, it can capture details like chicken at 30% off, cabbage at ¥100 per head, or two bottles of milk for ¥300. This information is sent to a server and stored in a database. Based on this data, the server proposes cost-effective meal plans.

Step 4: Reading Receipt Information

The user uses the device's camera to photograph past receipts. Using OCR technology, it can read the purchased product names, quantities, and prices in detail. For example, it extracts information such as milk 200 yen, bread 150 yen, tomatoes 100 yen, etc., is extracted, transmitted to the server, and stored. Based on this information, the server analyzes past purchase history and creates an optimal shopping plan within the budget.

Step 5: Menu Proposal

Based on information from the user registration unit, refrigerator management unit, image recognition unit, and receipt reading unit, the server proposes detailed meal plans for a week. For example:

"Omelet and Salad," lunch is "Chicken Sandwich," dinner is "Chicken Curry"; Tuesday's breakfast is "Yogurt and Fruit," lunch is "Tomato Pasta," dinner is "Grilled Fish," etc., presenting specific dish names and recipes. Recipes include ingredients, cooking steps, preparation time, and calorie information. A specific example of a prompt for the generative AI is: "Please propose a weekly meal plan considering the user's family composition and food preferences."

Step 6: Generating the Shopping List

The server generates a detailed shopping list of required ingredients based on the proposed meal plan. For example, it suggests specific purchase locations and quantities like: "Buy 500g of chicken at Supermarket A," "Buy 2 tomatoes at Supermarket B," "Buy 1L of milk at Supermarket C." Furthermore, it utilizes sale information to select the most economical purchase locations. An example prompt for the generative AI could be: "Generate the most economical shopping list based on sale information."

Step 7: Calorie Calculation and Health Management

The server calculates the detailed calories of the proposed meal plan and displays the total daily calorie intake. This facilitates health management for the user. For example, the user can adjust the meal plan to ensure the total daily calorie intake does not exceed 2000 kcal. A specific example of a prompt to feed into the generative AI is: "Calculate the calories of the proposed meal plan and provide advice for health management."

Step 8: Food Expense Management and Budget Adjustment

The server verifies whether purchases can be made within the budget and manages food expenses. For example, it indicates that the weekly budget is ¥5,000 and the ingredient cost for the proposed meal plan is ¥4,800. Furthermore, based on past purchase history, it suggests budget revisions or savings measures. A specific example of a prompt to feed into the generative AI is: "Please create an optimal shopping plan within the budget and provide savings suggestions."

Step 9: Menu Modification and Adjustment

Users can flexibly modify the proposed meal plan using their device to fit their actual circumstances. For example, if a sudden schedule change requires eating out, they can delete that day's meal plan and carry it over to the next day. They can also request a new meal plan proposal based on changes in family preferences. A specific example of a prompt to feed into the generative AI is: "Please flexibly modify the meal plan according to the user's situation."

### Specific Use Cases

For example, consider a household with four members where each family member has different food preferences and health conditions. In this household, the father prefers spicy food, the mother has a dairy allergy, one child requires a low-sugar diet due to diabetes, and the other child is vegetarian. In this situation, the user inputs detailed information about the family's food preferences, allergy information, health conditions, and their own cooking repertoire using the terminal. This enables the system to propose meal plans tailored to each member's needs.

Furthermore, the user inputs the types, quantities, and expiration dates of ingredients in the refrigerator. For example, the refrigerator might contain 6 eggs, 500ml of milk, 3 tomatoes, 300g of chicken, 2 blocks of tofu, and 1 bunch of spinach. Based on this information, the system can propose menus that prioritize using ingredients nearing their expiration date, thereby reducing food waste.

Users can also photograph supermarket flyers and use image recognition technology to capture sale information. For example, it can capture information such as chicken at 30% off, cabbage at ¥100 per head, or tofu at ¥150 for two blocks. Based on this information, the system proposes cost-effective meal plans.

Furthermore, users can photograph past receipts. Using OCR technology, the system reads purchased item names, quantities, and prices. For example, it extracts information such as milk for 200 yen, bread for 150 yen, tomatoes for 100 yen. By analyzing past purchase history, it creates an optimal shopping plan within the budget.

The system comprehensively utilizes this information to propose a weekly meal plan. For example, Monday's breakfast might be "Omelet and Salad," lunch "Chicken Sandwich," and dinner "Chicken Curry"; Tuesday's breakfast "Yogurt and Fruit," lunch "Tomato Pasta," and dinner "Grilled Fish." Recipes include ingredients, cooking steps, preparation time, and calorie information.

Based on the proposed menu, the system generates a shopping list for the necessary ingredients. For example, it suggests: it suggests specific purchase locations and quantities such as "Buy 500g of chicken at Supermarket A," "Buy 2 tomatoes at Supermarket B," and "Buy 1L of milk at Supermarket C." It can utilize sale information to select the most economical purchase locations.

Furthermore, the system calculates the calories for the proposed menu and displays the total daily calorie intake. This facilitates health management for the user. For example, the user can adjust the menu to ensure the total daily calorie intake does not exceed 2000 kcal.

The system also verifies whether purchases fit within the budget to manage food expenses. For example, it indicates that the weekly budget is ¥5,000 and the ingredient cost for the proposed menu is ¥4,800. Furthermore, based on past purchase history, it suggests budget adjustments or savings opportunities.

Users can flexibly modify the proposed meal plan to suit their actual circumstances. For example, if a sudden schedule change requires eating out, they can delete that day's meal plan and carry it over to the next day. They can also have the meal plan re-proposed based on changes in family preferences.

Specific examples of prompt sentences to be fed into the generative AI required for implementing the present invention include: "Please propose a weekly meal plan considering the user's family composition and food preferences," "Please devise a meal plan that efficiently utilizes ingredients in the refrigerator without waste," "Please generate the most economical shopping list based on sale information," "Please calculate the calories of the proposed meal plan and provide health management advice," "Please create an optimal shopping plan within the budget and suggest ways to save money," "Please flexibly adjust the meal plan based on the user's situation." This enables the system to provide optimal meal plans and shopping plans tailored to the user's needs.

### Application Example 1

The flow of specific processing in Application Example 1 is described below. The system components described hereafter are implemented by the data processing device 12 and the smart device 14. The data processing device 12 is referred to as the "server," and the smart device 14 is referred to as the "terminal."

### Implementation Examples for the Present Invention

As an embodiment for implementing the present invention, a system is provided that supports optimal menu proposals tailored to individual user needs and efficient ordering in a food delivery service. This system comprises a user information registration unit, a menu proposal unit, and an order management unit. By operating in coordination, these units provide users with a personalized dining experience.

First, the user information registration unit allows users to input detailed information via an application, including food preferences, allergy information, health status, and past order history. For example, users can register information such as liking spicy food, having a dairy allergy, or needing low-sugar meals due to diabetes. Furthermore, users can input individual requests such as being vegetarian or wanting to avoid specific ingredients. History of previously ordered menus and restaurants is also recorded, enabling more accurate understanding of user preferences. For instance, frequently ordered dishes or particularly well-rated menus are recorded to analyze user preferences.

Next, the Menu Proposal Section uses information obtained from the User Information Registration Section to propose optimal restaurants and menus for the user. For example, it selects restaurants offering spicy dishes matching the user's preferences and presents menus without dairy or low-sugar options. It also analyzes the user's past order history, prioritizing menu items they tend to prefer to enhance satisfaction. Furthermore, it utilizes real-time updates on special offers and promotions to make cost-effective suggestions. For instance, it proposes limited-time discounts at specific restaurants or menus applying promotional codes, offering economical choices for users. Since special offers vary by region, it can provide optimal information based on the user's location.

The Order Management Department calculates calories and provides nutritional information for suggested menus, facilitating users' health management. For instance, it adjusts the total calories of suggested menus to ensure they do not exceed the recommended daily intake and, when necessary, proposes alternative menus considering nutritional balance. Specifically, it can present menus enriched with nutrients tailored to the user's health status, taking into account vitamin and mineral intake. Users can also flexibly modify suggested menus according to their actual circumstances. This includes handling situations like canceling an order due to sudden schedule changes or switching to a different menu. Furthermore, the system learns from user feedback to improve the accuracy of future recommendations. Feedback includes aspects like the taste of the food, delivery time, and service quality. Analyzing this feedback enables the system to make recommendations that better suit the user.

This system enables users to efficiently utilize food delivery services, saving time and money while maintaining a healthy diet. Prompt examples for the generative AI include: Examples of prompt sentences fed to the generative AI include: "Please suggest the optimal menu considering the user's food preferences and health status," "Please generate the most economical order plan based on special sale information," "Please provide the calorie and nutritional information for the suggested menu," and "Please improve future suggestions based on user feedback." This enables the system to provide an optimal food delivery experience tailored to the user's needs.

### System Configuration

The system according to this embodiment comprises a user information registration unit, a menu proposal unit, and an order management unit. The user information registration unit allows users to input detailed information about their food preferences, allergy information, health status, and past order history through the application. For example, users can register information such as liking spicy food, having a dairy allergy, or needing low-sugar meals due to diabetes. Furthermore, users can input specific requests such as being vegetarian or wanting to avoid certain ingredients. History of previously ordered menus and restaurants is also recorded, enabling more accurate understanding of user preferences. For instance, frequently ordered dishes or particularly well-rated menus are recorded to analyze user preferences.

The Menu Proposal Section uses information obtained from the User Information Registration Section to propose optimal restaurants and menus for the user. For example, it selects restaurants offering spicy dishes matching the user's preferences and presents menus without dairy or low-sugar options. Furthermore, by analyzing the user's past order history and prioritizing menu items they tend to prefer, it enhances user satisfaction. Furthermore, it utilizes real-time updates on special offers and promotions to make cost-effective suggestions. For example, it proposes limited-time discounts at specific restaurants or menus applying promotional codes, providing economical choices for users. Since special offers vary by region, it can provide optimal information based on the user's location.

The Order Management Department calculates the calories of proposed menus and provides nutritional information to facilitate users' health management. For example, it adjusts the total calories of proposed menus to ensure they do not exceed the recommended daily intake and, if necessary, suggests alternative menus considering nutritional balance. Specifically, it can present menus enriched with nutrients tailored to the user's health status, taking into account vitamin and mineral intake. Users can also flexibly modify proposed menus according to their actual circumstances. This includes handling situations like canceling an order due to sudden schedule changes or switching to a different menu. Furthermore, the system learns from user feedback to improve the accuracy of future recommendations. Feedback includes aspects like the taste of the food, delivery time, and service quality. Analyzing this feedback enables the system to make recommendations that better suit the user.

Specific examples of prompt sentences to be fed into the generative AI required to implement the present invention include: "Please suggest the optimal menu considering the user's food preferences and health status," "Please generate the most economical order plan based on special sale information," "Please provide the calorie and nutritional information for the suggested menu," and "Please improve future suggestions based on user feedback." This enables the system to provide an optimal food delivery experience tailored to the user's needs.

### Implementation Steps

Step 1: User Information Registration

Users input detailed information through the application, including dietary preferences, allergy information, health status, and past order history. For example, they register information such as liking spicy foods, having a dairy allergy, or needing a low-sugar diet due to diabetes. They can also input specific requests, such as being vegetarian or wanting to avoid certain ingredients. Past menu and restaurant order histories are also recorded, enabling a more accurate understanding of the user's preferences.

Step 2: Optimal Menu Proposal

The menu proposal section uses information obtained from the user information registration section to propose the most suitable restaurants and menus for the user. For example, it selects restaurants offering spicy dishes that match the user's preferences and presents menus that do not use dairy products or are low-carb. Furthermore, it analyzes past order history and prioritizes proposing menus that the user tends to prefer. It utilizes real-time updated special offers and promotions to make cost-effective proposals. A specific example of a prompt to feed into the generative AI is: "Please propose the optimal menu considering the user's food preferences and health status."

Step 3: Order Management and Adjustment

The order management department calculates calories and provides nutritional information for proposed menus, facilitating user health management. For example, it adjusts the total calories of proposed menus to ensure they do not exceed the recommended daily intake and, if necessary, suggests alternative menus considering nutritional balance. Users can flexibly modify proposed menus according to their actual circumstances. A specific example of a prompt to feed into the generative AI is: "Provide new calorie and nutritional information for the proposed menu."

Step 4: Utilizing Feedback and Learning

Based on user feedback, learning is performed to improve the accuracy of future proposals. Feedback includes aspects such as the taste of the food, delivery time, and service quality. Analyzing this feedback enables proposals that better suit the user. A specific example of a prompt to feed into the generative AI is: "Improve the next proposal based on user feedback."

### Specific Use Cases

For example, consider a family of four where each member has different food preferences and health conditions. In this household, the father prefers spicy food, the mother has a dairy allergy, one child requires a low-sugar diet due to diabetes, and the other child is a vegetarian. In such a situation, the user inputs detailed information about the family's food preferences, allergy information, health conditions, and past order history through the application. This enables the system to propose meal plans tailored to each member's needs.

Based on information obtained from the user information registration section, the system proposes optimal restaurants and menus. For example, it selects restaurants offering spicy dishes for the father, presents menus without dairy products for the mother, suggests low-sugar menus for the diabetic child, and proposes meat-free menus for the vegetarian child. It also analyzes past order history to prioritize suggesting menus that satisfy the entire family. Furthermore, it utilizes real-time updates on special offers and promotions to make cost-effective suggestions. For example, it provides economical choices by suggesting limited-time discounts at specific restaurants or menus applying promotional codes.

The Order Management Department calculates the calories of proposed menus and provides nutritional information, making it easier for the entire family to manage their health. For example, it adjusts the total calories of proposed menus to ensure they do not exceed the recommended daily intake and, if necessary, suggests alternative menus considering nutritional balance. Specifically, it can present menus enriched with nutrients tailored to the family's health status, taking into account vitamin and mineral intake. Furthermore, users can flexibly modify the proposed menu according to their actual circumstances. For example, this accommodates situations like canceling an order due to sudden schedule changes or switching to a different menu.

Furthermore, based on user feedback, the system learns to make more accurate proposals for future orders. Feedback includes aspects such as the taste of the food, delivery time, and service quality. By analyzing this feedback, it becomes possible to make proposals that better suit the user.

Specific examples of prompt sentences to be fed into the generative AI required for implementing the present invention include: "Please suggest the optimal menu considering the user's family composition and food preferences," "Please generate the most economical order plan based on special sale information," "Please provide the calorie and nutritional information for the suggested menu," and "Please improve future suggestions based on user feedback." This enables the system to provide an optimal food delivery experience tailored to the user's needs.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others can perform various processing tasks, but are not limited to these examples. Furthermore, AI may be implemented as an AI agent. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

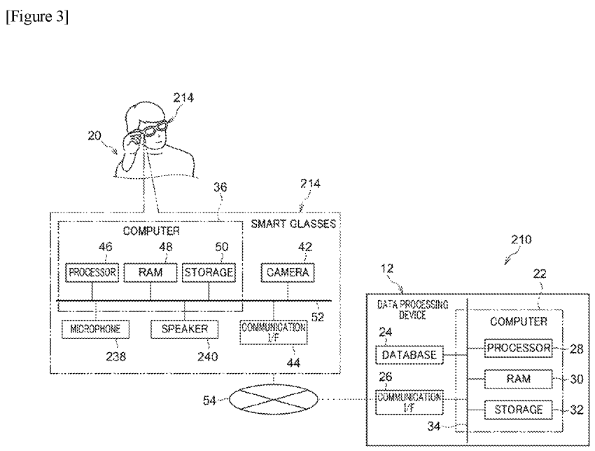

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

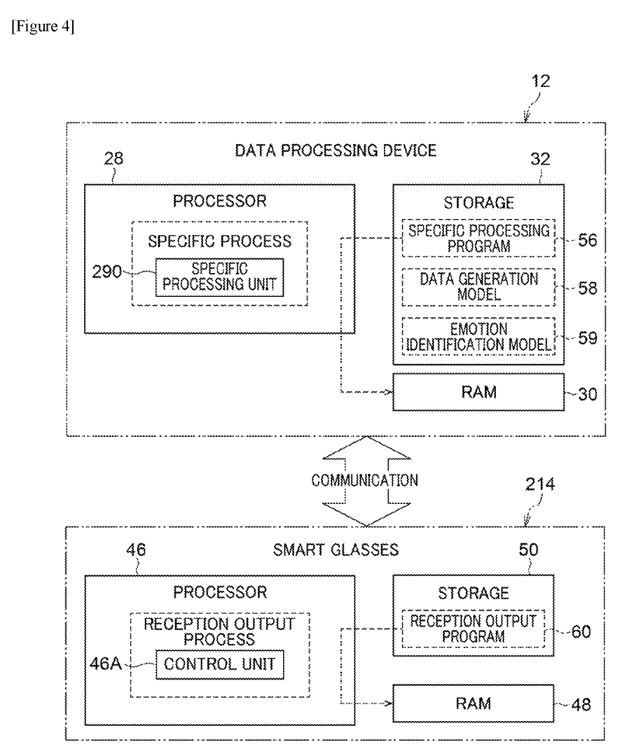

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart glasses 214 perform reception output processing via the processor 46. The reception output program 60 is stored in the storage 50. The processor 46 reads the reception output program 60 from the storage 50 and executes the read reception output program 60. Reception output processing is realized by the processor 46 operating as control unit 46A according to reception output program 60 executed on RAM 48. Furthermore, the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

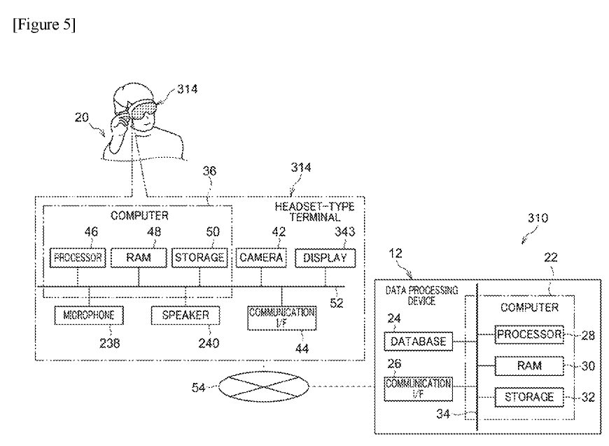

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions and the like from user 20. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

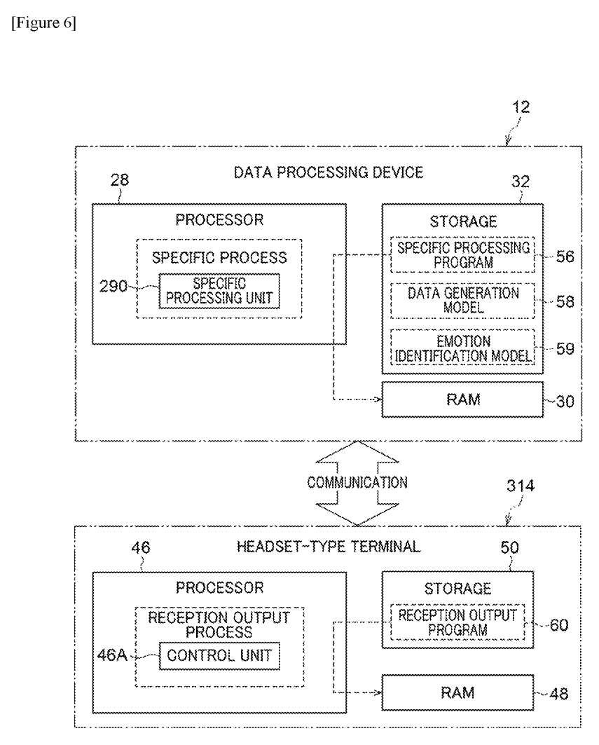

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing is the same as that described in Example 1 of the first embodiment above; therefore, the description is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

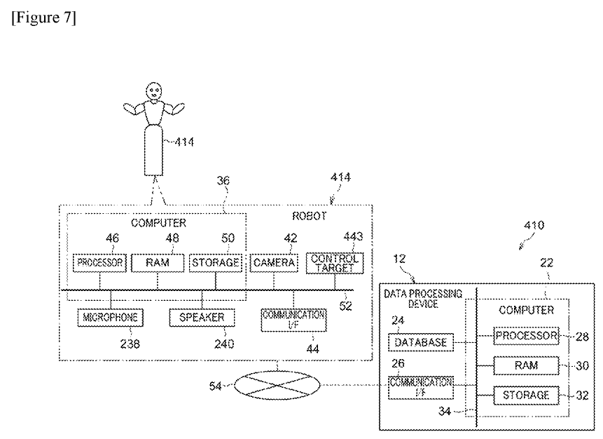

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

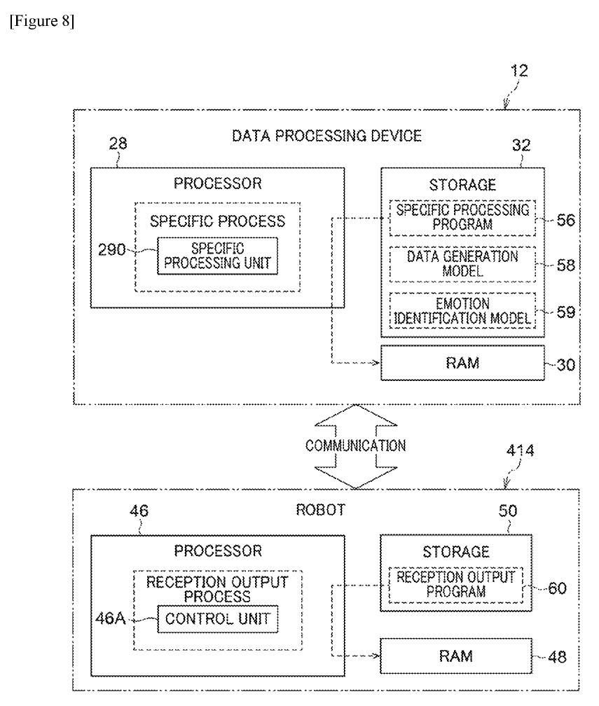

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12, etc., includes multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others and can perform various processing tasks, but are not limited to these examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

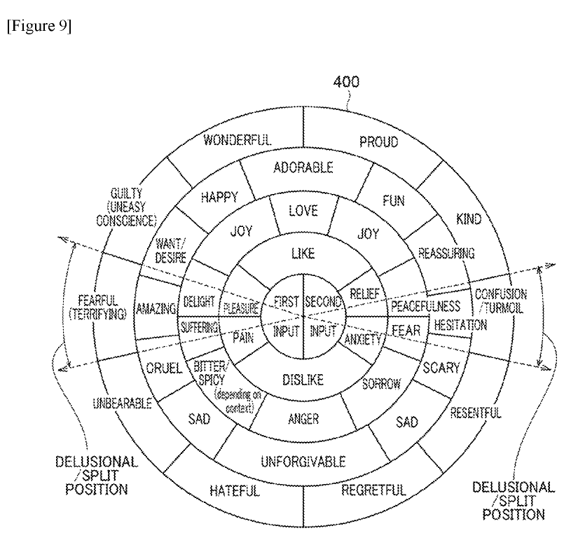

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Additionally, the upper part of the concentric circle houses "pleasant" emotions, while the lower part houses "unpleasant" emotions. Thus, in Emotion Map 400, multiple emotions are mapped based on the structure from which emotions arise, with emotions that tend to occur simultaneously mapped closer together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of Emotion Map 400 represents the mind, while the outer part represents behavior. Therefore, the further outward one goes on Emotion Map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Based on research on speech emotion recognition and neurophysiological signal analysis of emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

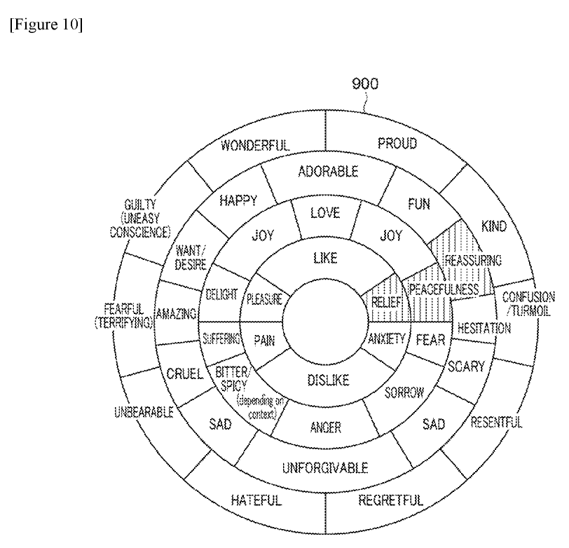

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable computer-readable non-volatile storage medium such as a USB (Universal Serial Bus) memory. The specific processing program 56 stored on the non-volatile storage medium may be stored on a portable USB memory or similar device. Program 56 may be stored on a portable computer-readable non-volatile storage medium, such as a USB (Universal Serial Bus) memory. The specific processing program 56 stored on the non-volatile storage medium is installed on the computer 22 of the data processing device 12. The processor 28 executes the specific processing according to the specific processing program 56.

Alternatively, the specific processing program 56 may be stored on a storage device, such as a server, connected to the data processing device 12 via the network 54. Upon request from the data processing device 12, the specific processing program 56 may be downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor has memory either built-in or connected, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing the specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects pertaining to the technology disclosed herein. Therefore, it goes without saying that within the scope that does not deviate from the main purpose of the technology disclosed herein, unnecessary portions may be omitted, new elements may be added, or replacements may be made to the above-described content and illustrated content. Furthermore, to avoid confusion and facilitate understanding of the portion pertaining to the technology disclosed herein, descriptions of technical common knowledge and the like that are not particularly necessary for enabling the implementation of the technology disclosed herein have been omitted from the above-described content and illustrated content. To facilitate understanding of the technical aspects of the present disclosure, descriptions of common technical knowledge that are not particularly necessary for enabling the implementation of the present disclosure have been omitted from the above descriptions and illustrations.

All literature, patent applications, and technical specifications cited herein are incorporated by reference to the same extent as if each individual literature, patent application, and technical specification were specifically and individually cited herein.

Regarding the above embodiments, the following is further disclosed.

### Supplementary note 1

A system comprising a user information registration unit, a menu proposal unit, and an order management unit, wherein the user information registration unit has a function to register in detail the user's food preferences, allergy information, health status, and past order history, and the menu proposal unit has a function to propose the optimal restaurant and menu for the user based on information obtained from the user information registration unit, and further has a function to make cost-effective proposals utilizing special sale information and promotions, characterized in that the order management unit calculates the calories of the proposed menu and provides nutritional information, and has the function of allowing the user to flexibly modify the proposed menu according to their actual situation.

### Supplementary note 2

The menu proposal unit analyzes the user's past order history, prioritizes proposing menus the user tends to prefer, and further provides economical choices based on real-time updated special sale information and promotions, characterized by the system described in Supplementary note 1.

### Supplementary note 3

The order management unit is characterized by the system described in Supplementary note 1, wherein it calculates the calories of the proposed menu in detail, provides nutritional information to facilitate the user's health management, and further learns based on user feedback to make subsequent proposals more accurate.

### SYMBOL EXPLANATION

10, 210, 310, 410 Data Processing System

12 Data Processing Device

14 Smart Device

214 Smart Glasses

314 Headset-type Terminal

414 Robot

What is claimed is:

1. A meal planning and ingredient purchasing support system, comprising:
a terminal device configured to receive user input; and
a server including one or more processors and a database, the server being configured to execute:
a user information registration unit configured to receive, from the terminal device, user information including family food preferences, allergy information, health status, and dishes the user is capable of preparing, and to store the user information in the database;
a refrigerator management unit configured to store and manage ingredient information including types, quantities, and expiration dates of ingredients contained in a refrigerator;
an image recognition unit configured to extract sale information from images of supermarket flyers captured by the terminal device;
a receipt reading unit configured to extract purchase history information from images of receipts captured by the terminal device using optical character recognition;
a meal plan proposal unit configured to generate a meal plan using a generative artificial intelligence model based on the user information, the ingredient information, the sale information, and the purchase history information;
a shopping list generation unit configured to generate a shopping list corresponding to the meal plan and to suggest purchase locations;
a calorie calculation unit configured to calculate calorie information for the meal plan;
a food expense management unit configured to determine whether purchases corresponding to the shopping list satisfy a budget condition; and
a meal plan modification unit configured to modify the meal plan in response to user input.

2. The system of claim 1, wherein the meal plan proposal unit generates a weekly meal plan including specific dish names and recipe information.

3. The system of claim 1, wherein the refrigerator management unit prioritizes use of ingredients having expiration dates within a predetermined period.

4. The system of claim 1, wherein the image recognition unit extracts discount rates and sale prices from the supermarket flyers.

5. The system of claim 1, wherein the receipt reading unit records item names, quantities, and prices as purchase history.

6. The system of claim 1, wherein the meal plan modification unit enables deletion, replacement, or rescheduling of meals in the meal plan.

7. A computer-implemented method for supporting meal planning and ingredient purchasing, comprising:
receiving user information including family food preferences, allergy information, health status, and dishes a user is capable of preparing, and storing the user information in a database;
receiving ingredient information including types, quantities, and expiration dates of ingredients contained in a refrigerator;
extracting sale information from images of supermarket flyers using image recognition processing;
extracting purchase history information from images of receipts using optical character recognition processing;
generating, using a generative artificial intelligence model, a meal plan based on the user information, ingredient information, sale information, and purchase history information;
generating a shopping list corresponding to the meal plan and suggesting purchase locations;
calculating calorie information for the meal plan;
evaluating whether the shopping list satisfies a budget condition; and
presenting the meal plan and the shopping list to a user and modifying the meal plan in response to user input.

8. The method of claim 7, wherein the meal plan comprises breakfast, lunch, and dinner for multiple days.

9. The method of claim 7, wherein the generating of the meal plan includes generating recipe information including ingredients and cooking steps.

10. The method of claim 7, wherein the shopping list includes quantities of ingredients and corresponding purchase locations.

11. The method of claim 7, wherein the calorie information includes a total daily calorie intake.

12. The method of claim 7, wherein the budget condition is determined based on past purchase history.

13. A non-transitory computer-readable medium storing instructions that, when executed by one or more processors, cause the processors to:
store user information including family food preferences, allergy information, health status, and dishes a user can prepare;
store ingredient information including types, quantities, and expiration dates of ingredients in a refrigerator;
extract supermarket sale information from images using image recognition processing;
extract purchase history information from receipt images using optical character recognition;
generate a meal plan using a generative artificial intelligence model based on the user information, ingredient information, sale information, and purchase history information;
generate a shopping list corresponding to the meal plan and suggest purchase locations;
calculate calorie information for the meal plan;
determine whether purchases satisfy a budget condition; and
output the meal plan and shopping list for display and modification by a user.

14. The non-transitory computer-readable medium of claim 13, wherein the meal plan is generated for a one-week period.

15. The non-transitory computer-readable medium of claim 13, wherein the instructions cause prioritization of ingredients nearing expiration.

16. The non-transitory computer-readable medium of claim 13, wherein the instructions cause utilization of sale information to reduce total ingredient cost.

17. The non-transitory computer-readable medium of claim 13, wherein the instructions cause recalculation of calorie information when the meal plan is modified.

18. The non-transitory computer-readable medium of claim 13, wherein the instructions are provided as part of a software-as-a-service platform.
